(19) United States
(12) Patent Application Publication
(10) Pub. No.: US 2022/0071108 A1
(43) Pub. Date: Mar. 10, 2022

(54) ENVIRONMENTALLY CONTROLLED FOOD PRODUCT WITH INTEGRATED PHOTOVOLTAIC POWER GENERATION SYSTEM

(71) Applicants: Ryan REDFORD, Irvine, CA (US); Norman P. SOLOWAY, Tucson, AZ (US)

(72) Inventors: Ryan REDFORD, Irvine, CA (US); Norman P. SOLOWAY, Tucson, AZ (US)

(21) Appl. No.: 17/467,031

(22) Filed: Sep. 3, 2021

Related U.S. Application Data
(60) Provisional application No. 63/074,921, filed on Sep. 4, 2020.

(51) Int. Cl. A01G 9/26; H02S 40/38; H02J 3/32; H02J 3/38; G06Q 40/04; G06Q 50/02; G06Q 50/06; G05B 15/02

(52) U.S. Cl. CPC A01G 9/26; H02S 40/38; H02J 3/32; H02J 3/381; G06Q 40/04; A01K 63/00; G06Q 50/06; G05B 15/02; H02J 2300/24; H02J 2300/28; G06Q 50/02

(57) ABSTRACT

A food and plant production system includes an environmentally controlled agriculture system integrated with an electrical energy microgrid, wherein the electrical energy microgrid includes an electrical powered energy generation system coupled with an electrical energy flow battery storage system.

### CROSS REFERENCE TO RELATED APPLICATION

This application claims benefit to U.S. Provisional Patent Application Ser. No. 63/074,921, filed Sep. 4, 2020, the contents of which are incorporated herein by reference.

### BACKGROUND OF THE DISCLOSURE

The present disclosure relates to environmentally controlled food and plant production system with a self-contained electrical power generation and storage system. The disclosure has particular utility in connection with greenhouse agriculture and will be described in connection with such utility, although other utilities are contemplated such as aquaculture including the rearing of aquatic animals and/or cultivation of aquatic plants for food, as well as combined greenhouse agriculture and aquaculture integrating aquaponics and agriculture.

Controlled agriculture production of food and other plants is becoming more widely adopted as the world's population increases, and the climate is changing. Also, there is a movement toward increased production of food and other plant crops in urban areas, e.g., on building rooftops. Growing food and plant crops in controlled environment has advantages in that it enables year-round production of high yields of high quality food and plant products coupled with reduction of or elimination of loss from pests. By way of example, one can product 20 to 50 times more lettuce per acre in a greenhouse controlled environment than in a field in California (Source: https://research.cornell.edu/news-features/growing-worlds-food-greenhouses).

Greenhouse production of food and plants also permits growing of temperature sensitive crops in cold climates and urban areas including rooftops, etc. However, in order to enjoy the greatest benefits from greenhouse growing, greenhouses require artificial lighting and climate control systems that add energy costs. Artificial lighting and climate control also is required to compensate or to supplement natural sunlight light during periods of cloudiness, and to extend growth times and the growing season.

Electricity used to power the auxiliary lighting and climate control systems typically is provided by the electrical power grid. However, purchasing electricity from the electrical grids adds significantly to the cost of the food and plant production.

Alternative power sources can be used in conjunction with the electrical power grid including, for example, stand-alone photovoltaic electrical power generation systems. However, stand-alone photovoltaic electrical power generator systems still require electrical grid backup which adds costs. Also in the event of a disruption of the electrical power grid, for example, during a storm or nearby fire, if photovoltaic electrical power generation also is insufficient the loss of power from the grid could impact significantly crop production, potentially resulting in the loss of a crop, with such risks increasing particularly during the winter and/or in colder climates where the temperature in the greenhouse would drop significantly as a consequence of power outage.

Similarly, in the case of controlled aquaculture production of fish and aquatic plants, electricity is needed in order to drive pumps for water circulation and filtration. Also, to maintain production during cooler growing seasons, i.e., when the water cools, the water must be heated to keep it at optimal production temperature.

### SUMMARY OF THE DISCLOSURE

The present disclosure overcomes the aforesaid and other technical problems of the prior art by integrating a self-contained electrical power generation and electrical energy storage system with an environmentally controlled agriculture system such as a greenhouse or aquaculture pond.

PCT/US2020/027940 published application, incorporated herein by reference, describes a photovoltaic electrical energy power generation system coupled with electrical energy storage flow batteries. Forming an electrical energy microgrid incorporating a photovoltaic electric power generation system or other green electrical power generation systems with electrical energy storage flow batteries offers an attractive alternative for providing electrical energy to environmentally controlled food production installations such as greenhouses and aquaculture systems. Of particular importance with the use of any renewable energy electrical eco-system is an efficient and cost effective storage battery system such as described in said PCT/US2020/027940 published application, which leverages redox flow batteries. Redox flow electrical energy batteries exhibit high energy conversion efficiency, are flexible in design architecture for easy scaling, providing high density electrical energy storage, flexible location options with deep discharge benefits, have high safety features along with environmental friendliness, and low maintenance costs compared to other types of electrical energy storage systems such as lead acid batteries, alkali salt batteries and lithium ion batteries which are expensive and are environmentally much more hazardous. The combination of the various above characteristics including specifically thermal energy storage characteristics makes redox flow electrical energy batteries particularly useful for off the grid, i.e., microgrid installations for greenhouse and aquaculture food and plant production installations.

In one aspect, there is provided a food and plant production system comprising an environmentally controlled agriculture system integrated with an electrical energy microgrid, wherein the electrical energy microgrid includes an electrical power energy generation system coupled with an electrical energy flow battery storage system. The environmentally controlled agriculture system may comprise a greenhouse or an aquaculture pond.

In one aspect, the greenhouse includes one or more electrical energy power consuming devices selected from the group consisting of growth lamps, heaters, air circulating fans and water circulation pumps. Dehumidification of greenhouses which is desirable in the winter as it lowers the energy requirements to provide heating, also can be powered by the microgrid system. And, a geothermal energy source could be used to dehumidify the ambient air and provide additional pre-heating source as well, also powered by the microgrid system.

In another aspect the microgrid system comprises an electrical energy generating system selected from the group consisting of photovoltaic cells, a wind power electrical energy generator(s), a tidal power electrical energy generator(s) and solar thermal and/or Geothermal power electrical energy generator(s).

In another aspect the electrical energy flow battery is comprised of a redox flow battery.

In yet another aspect, the electrical energy flow battery is located within or under a greenhouse or adjacent to or under an aquaculture pond.

In yet another aspect, when the microgrid electrical energy and storage system employs an environmentally friendly electrical energy generation system, in combination with a greenhouse or aquaculture pond, or aqueous pond, the system may create tradeable carbon credits for the carbon dioxide consumed by the growing plants or animals.

### BRIEF DESCRIPTION OF THE DRAWINGS

Further features and advantages of the present disclosure will be seen from the following detailed description, taken in conjunction with the accompany drawings, wherein numerals depicts sub-parts of various system configurations, and wherein:

FIG. 1 is a schematic flow-diagram illustrating integration of a microgrid electrical energy generation and storage system including a redox flow battery with a greenhouse in accordance with a first embodiment of the present disclosure;

FIG. 2 is a block flow-diagram illustrating operation of the microgrid/greenhouse of FIG. 1;

FIG. 3 is a schematic flow-diagram illustrating integration of a microgrid electrical energy generation and storage system with an aquaculture food production installation in accordance with an alternative embodiment of the present disclosure; and

FIG. 4 is a block flow-diagram illustrating operation of the microgrid/aquaculture installation of FIG. 3.

### DETAILED DESCRIPTION OF THE PRESENT INVENTION

Modes for carrying out the present disclosure will be described, with reference to the drawings.

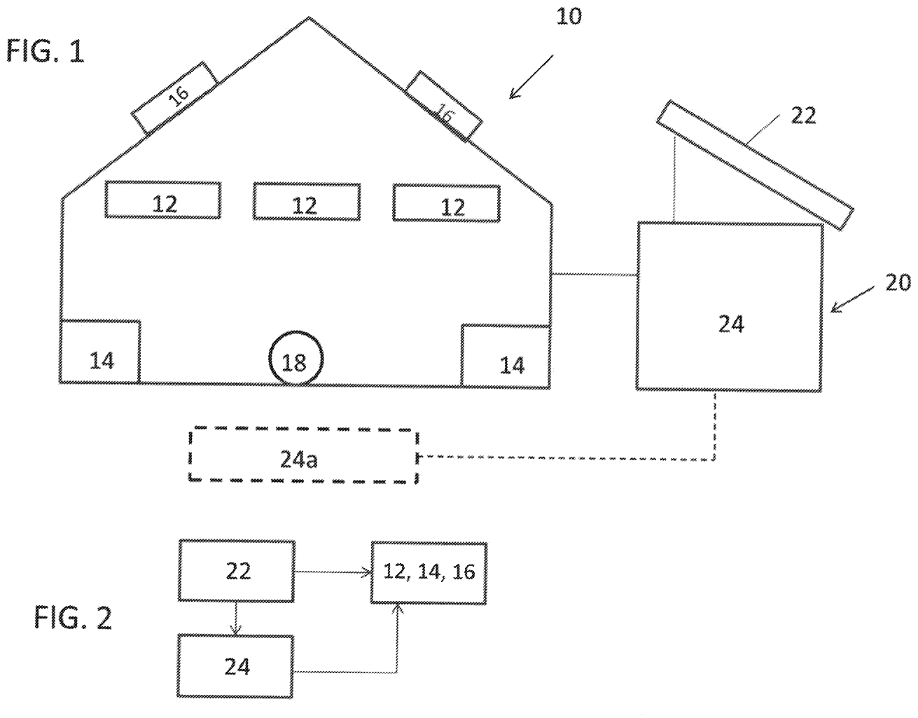

FIGS. 1 and 2 are schematic and block flow diagrams showing a microgrid/greenhouse integration according to a first embodiment with the present disclosure. According to FIGS. 1 and 2, the system includes a greenhouse 10 including growth lamps 12, heaters 14, air circulation fans 16 and water circulation pumps 18. Greenhouse 10 is of conventional design and need not be further described.

The integrated system also includes an electrical energy generation and storage microgrid 20. The microgrid may be standalone, or integrated with a power grid.

The microgrid includes electrical energy source 22 which in a preferred embodiment comprises a renewable energy source such as a bank of photovoltaic cells. Electricity developed by electrical energy source 22 is delivered directly to the greenhouse for driving the lamps 12, heaters 14, fans 16 and pumps 18, etc. as necessary, and excess electrical energy generation is passed to an electrical energy storage system which in a preferred embodiment comprises a redox flow electrical energy batteries 24 such as described in said published PCT Application.

Redox flow energy batteries 24 may be located outside to greenhouse 10. However, in a preferred embodiment, show in phantom at 24a, the redox flow electrical energy storage batteries are located inside or under the greenhouse so that excess heat energy may be absorbed by the batteries and then released into the interior of the greenhouse in the evening, or when the sun is obscured by clouds, and/or during cooler weather.

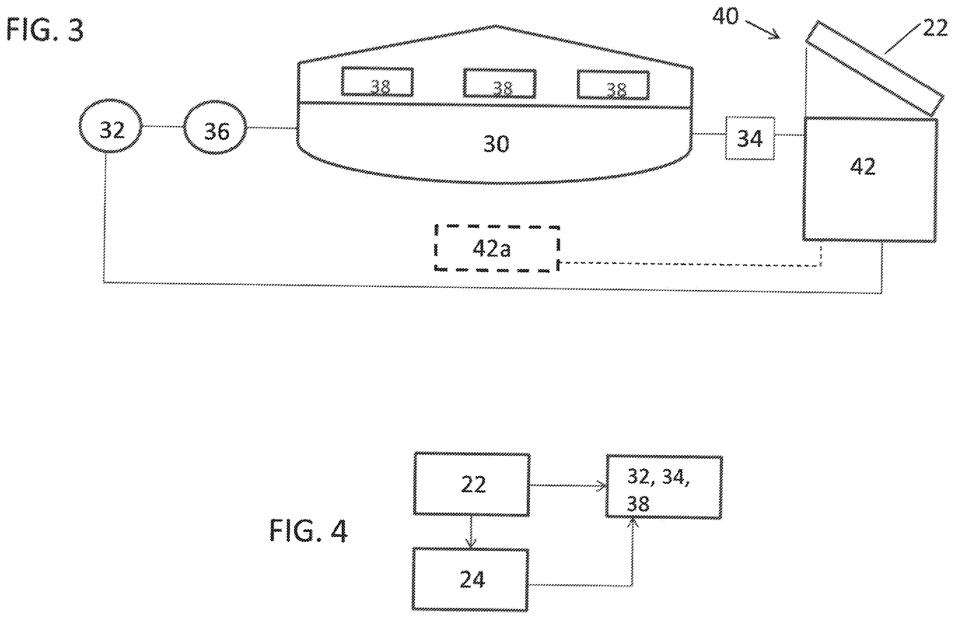

Referring to FIG. 3, alternatively, the microgrid may be associated with an aquaculture pond 30. Aquaculture pond 30 includes pumps 32, heaters 34, filters 36, lights 38, etc., and may be open to the air, but preferably is glassed over 40 for year round use. As in the case with a greenhouse described above, electrical energy is supplied to pumps 32, heaters 34, and lights 38 from microgrid 20 which is similar to microgrid 10 discussed above, and the excess electrical energy passed to an electrical energy storage system 40 which in a preferred embodiment comprises redox flow batteries 42 such as described in said PCT/US2020/027940 published application. Similar to FIG. 1 discussed above, the electrical energy stored by the redox flow batteries 42 may be used to drive the pumps, etc., when the sun is obscured and/or at night. Also, excess heat from the batteries may be tapped for heating the water. As in the case of a greenhouse, the redox flow batteries may be located adjacent the pond, or under the pond as shown in phantom at 42a.

As can be seen from the foregoing, the present disclosure provides environmentally controlled greenhouse or aquaculture with an integrated electrical energy generation and storage system that is designed to provide self-sustainable energy with increased growing production thereby increasing growing seasons.

The advantages of the present invention include: (1) the integrated food or plant crop growing system and microgrid electrical energy generation and storage system is environmentally friendly, and is self-sustainable and capable of growing a wide variety of food and plant crops; (2) the integration of a microgrid electrical energy generation and storage system with a food or plant crop growing system significantly reduces food and crop production costs; and (3) the integration of a microgrid electrical energy generation and storage system with a food or plant crop growing system enables the capture and storage of excess thermal energy in the flow batteries for release during cooler evening hours and/or during cooler seasons, and/or at times when the sun is obscured, providing significant increased production capabilities and also reduces food and crop losses and/or stunted crop growth risk and mitigates risks to crops so they can withstand storms or a loss of electrical energy from the local grid service provider.

Various changes may be made the above disclosure without departing from the spirit and scope thereof. For example, while the system has been described as a microgrid electrical energy generation and storage system preferably employing photovoltaic electrical energy generation systems, other environmentally friendly electrical energy generation systems such as wind power systems, tidal power systems or geothermal power systems advantageously may be used. And, since growing plants consume carbon dioxide, the system also may be employed to create tradable carbon credits. Also, while it is preferred that the electrical energy comprises a renewable energy source, the electrical energy source also may be connected to mains so that the flow batteries may be recharged during off peak time resulting in cost saving.

Various other changes may be made without departing from the spirit and scope of the above disclosure.

What is claimed:

1. A food and plant production system comprising an environmentally controlled agriculture system integrated with an electrical energy microgrid, wherein the electrical energy microgrid includes an electrical power energy generation system coupled with an electrical energy flow battery storage system.

2. The food and plant production system of claim 1, wherein the environmentally controlled agriculture system comprises a greenhouse.

3. The food and plant production system of claim 2, wherein the greenhouse includes one or more electrical energy power consuming devices selected from the group consisting of growth lamps, heaters, air circulating fans and water circulation pumps, powered by the microgrid system.

4. The food and plant production system of claim 1, wherein the microgrid system comprises an electrical energy generating system selected from the group consisting of photovoltaic cells, a wind powered electrical energy generator, a tidal powered electrical energy generator and a thermal power electrical energy generator.

5. The food and plant production system of claim 1, wherein the electrical energy flow battery comprises a redox flow battery.

6. The food and plant production system of claim 2, wherein the electrical energy flow battery is located within or under the greenhouse.

7. The food and plant production system of claim 1, wherein the environmentally controlled agriculture system comprises an aquaculture pond.

8. The food and plant production system of claim 7, wherein the aquaculture pond includes one or more electrical energy power consuming devices selected from the group consisting of growth lights, water pumps, and heaters powered by the microgrid system.

9. The food and plant production system of claim 7, wherein the electrical energy generator comprises an electrical energy generating system selected from the group consisting of photovoltaic cells, a wind powered electrical energy generator, a tidal powered electrical generator and a thermal powered electrical energy generator.

10. The food and plant production system of claim 7, wherein the electrical energy flow battery comprises a redox flow cell.

11. The food and plant production system of claim 7, wherein the electrical energy flow battery is located in or under the pond.

12. A method for creating tradable carbon credits which comprises providing a food or plant production system integrated with an electrical energy microgrid system, wherein the electrical energy microgrid includes an environmentally friendly electrical power energy generation system coupled with an electrical energy flow battery system, and extracting carbon dioxide from the atmosphere by the growing plants.

13. The method of claim 12, wherein the food or plant production system comprises a greenhouse which includes one or more electrical energy power consuming devices selected from the group consisting of growth lamps, heaters, air circulating fans and water circulation pumps, powered by the electrical energy microgrid system.

14. The method of claim 12, wherein the electrical energy microgrid system comprises an electrical energy generating system selected from the group consisting of a photovoltaic cell, a wind powered electrical energy generator, a tidal powered electrical energy generator and a thermal power electrical energy generator.

15. The method of claim 12, wherein the electrical energy flow battery comprises a redox flow battery.

16. The method of claim 13, wherein the electrical energy flow battery is located within or under the greenhouse.

17. The method of claim 12, wherein the food or plant production system comprises an aquaculture pond.

18. The method of claim 17, wherein the aquaculture pond includes one or more electrical energy power consuming devices selected from the group consisting of growth lights, water pumps, and heaters powered by the microgrid system.

19. The method of claim 17, wherein the electrical energy flow battery is located in or under the pond.

20. The method of claim 12, wherein the electrical energy microgrid system comprises an electrical energy generating system selected from the group consisting of photovoltaic cells, a wind powered electrical energy generator, a tidal powered electrical generator and a thermal powered electrical energy generator.
